(19) United States
(12) Patent Application Publication
(10) Pub. No.: US 2011/0055891 A1
(43) Pub. Date: Mar. 3, 2011

(54) DEVICE SECURITY

(76) Inventor: Christopher T. Rice, San Antonio, TX (US)

(21) Appl. No.: 12/548,378

(22) Filed: Aug. 26, 2009

(51) Int. Cl. G06F 21/00

(52) U.S. Cl. 726/2; 726/27

(57) ABSTRACT

Security of a device, such as a mobile device, is maintained via a heartbeat signal. As long as the heartbeat signal is detected, the device is allowed to perform operations. If the heartbeat signal is not detected, appropriate action is taken. Appropriate action can include powering down the device, restricting access to files, erasing files, erasing the contents of a disk on the device, preventing access to designated files, reporting the location of the device, and/or preventing the device from being turned on after it is turned off. In an example configuration, the heartbeat signal is a low-power consuming, low data rate, signal allowing for processing of the heartbeat signal to be accomplished, at least in part, via the SIM of the device.

### TECHNICAL FIELD

The technical field relates generally to maintaining security of a device, and more specifically relates to maintaining security of a device via a heartbeat signal.

### BACKGROUND

Wireless communications devices such as cellular telephones, mobile communication devices, personal digital assistants (PDAs), wireless headsets, laptops, and the like are becoming more prevalent as users appreciate the smaller form factors and the mobility of the devices. Wireless communications devices may be lost, forgotten, stolen, or in any way removed from the user. Because the devices are generally portable, it may be easy to leave one behind when going from one place to another. For example, a user may accidentally leave a laptop behind in a conference room at the conclusion of a meeting.

Losing a wireless communications device can be very disruptive. Not only does the user lose the use of the device, but perhaps even more disruptive is the loss of important information stored on the device. Or possibly worse, the important information may be accessible by unauthorized persons. For example, wireless communications devices can store valuable personal information such as telephone lists, text-messages, e-mails, documents, spread sheets, instant messages, financial information, social security numbers, and the like. Wireless communications devices also can store valuable business information. For example, the e-mail stored in a business person's PDA may contain extremely valuable corporate information, such as sales data, strategy, and new product information that has not been released to the public.

### SUMMARY

Security of a device, such as a wireless device, is maintained via a heartbeat signal. The device monitors the heartbeat signal. As long as the heartbeat signal is detected, the device determines that the device is secure and allows operation of the device. If the heartbeat signal is not detected, it is determined that the device is not secure and appropriate action is taken. Appropriate action can include, for example, shutting the device down, restricting access to designated functions, files, and/or applications, reporting the location of the device, preventing the device from being turned on after it is turned off, or a combination thereof. In an example embodiment, the location of the device is monitored. If the device moves into or out of a designated geographic area, the heartbeat signal is discontinued, thus triggering an appropriate action. In an example configuration, the heartbeat signal is implemented as a low power consuming, low data rate, heartbeat signal between the device and a network. Processing of the heartbeat signal can be handled via a subscriber identity module (SIM) of the device.

### BRIEF DESCRIPTION OF THE DRAWINGS

The following description is better understood when read in conjunction of the appended drawings.

FIG. 1 is a depiction of an architecture for maintaining device security via a heartbeat signal.

FIG. 2 is a flow diagram of an example process for maintaining security of a device via a heartbeat signal.

FIG. 3 is a block diagram of an example device.

FIG. 4 is a block diagram of an example security policy server configured to maintain device security via a heartbeat signal.

FIG. 5 depicts an overall block diagram of an exemplary packet-based mobile cellular network environment, such as a GPRS network, in which device security can be maintained via a heartbeat signal.

FIG. 6 illustrates an architecture of a typical GPRS network in which device security can be maintained via a heartbeat signal.

FIG. 7 illustrates an example block diagram of a GSM/GPRS/IP multimedia network architecture within which device security can be maintained via a heartbeat signal.

### DETAILED DESCRIPTION

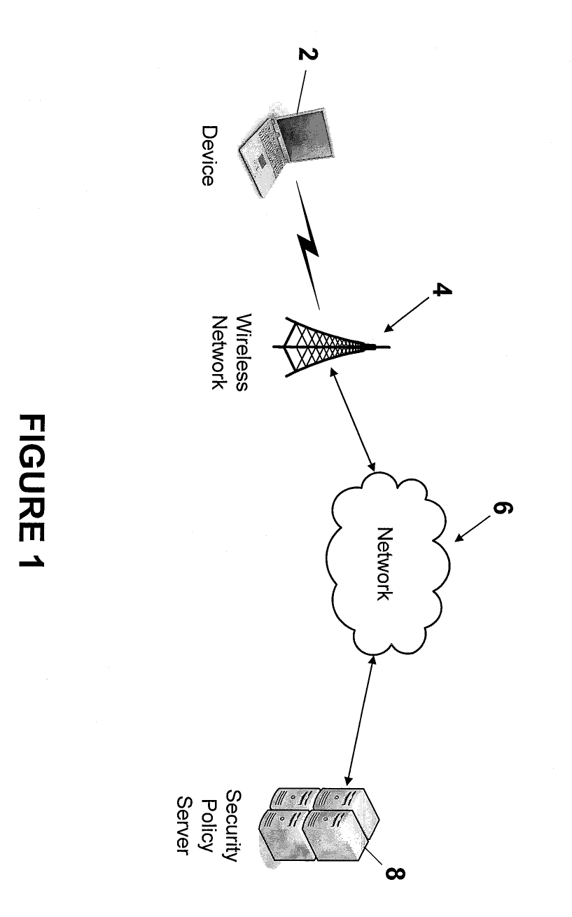

Referring to FIG. 1, security of a device 2 is maintained via a heartbeat signal. As long as the heartbeat signal is detected, the device 2 is allowed to perform operations. If the heartbeat signal is not detected, appropriate action is taken. Appropriate action can include, for example, powering down the device, restricting access to files, erasing files, erasing the contents of a disk on the device, preventing access to designated files, reporting the location of the device, preventing the device from being turned on after it is turned off, or a combination thereof.

In various embodiments, the heartbeat signal can be provided by the device 2 to the security policy server 8, provided by the security policy server 8 to the device 2, or a combination thereof. For example, in one embodiment, the heartbeat signal is provided by the device 2 to the security policy server 8. The heartbeat signal can be provided either periodically or aperiodically. If the security policy server 8 receives the heartbeat signal from the device 2 within expected time periods, the device 2 is allowed to operate normally. If the security policy server 8 does not receive the heartbeat signal from the device 2 within expected time periods, the security policy server 8 sends a message to the device 2 indicating that appropriate action is to be taken.

In another example embodiment, the heartbeat signal is provided by the security policy server 8 to the device 2. The heartbeat signal can be provided either periodically or aperiodically. If the device 2 receives the heartbeat signal from the security policy server 8 within expected time periods, the device 2 is allowed to operate normally. If the device 2 does not receive the heartbeat signal from the security policy server 8 within expected time periods, the device 2 takes appropriate action.

In yet other example embodiments, the heartbeat signal is initiated by the security policy server 8 or the device 2, and the recipient of the heartbeat signal provides a response indicating receipt of the heartbeat signal. For example, the security policy server 8 can send the heartbeat signal to the device 2, and the device 2, upon receipt of the heartbeat signal, sends a response signal to the security policy server 8 indicating receipt of the heartbeat signal. Or, the device 2 can send the heartbeat signal to the security policy server 8, and the security policy server 8, upon receipt of the heartbeat signal, sends a response signal to the device 2 indicating receipt of the heartbeat signal. The initiator of the heartbeat signal can be configured into the device 2 during manufacture, selectable by a user of the device 2, determined by the security policy server 8, or any combination thereof. The heartbeat signal can be provided either periodically or aperiodically. In either embodiment (device 2 initiates heartbeat signal or security policy server initiates heartbeat signal), if the response signal is received within expected time periods, the device 2 is allowed to operate normally. If the response signal is not received within expected time periods, the device 2 takes appropriate action. In the first embodiment, if the security policy server 8 does not receive the response signal, the security policy server 8 sends an indication to the device 2 to take appropriate action. In the second embodiment, if the device 2 does not receive the response signal, the device 2 takes appropriate action.

In various embodiments, the heartbeat signal can be implemented as a telemetric signal between the device 2 and a security policy server 8. For example, the security policy server 8 can send the heartbeat signal to the device 2, and the device 2 responds with information about the device 2, such as, for example, the location of the device 2, applications that have been executed on the device 2, files that have been accessed on the device 2, if applications or files that are designated as restricted have been executed/accessed, or the like.

The heartbeat signal can be implemented via any appropriate type of signal. For example, the heartbeat signal can comprise a burst of RF (radio frequency) energy transmitted repeatedly at an appropriate data rate. The burst can be periodically transmitted, aperiodically transmitted, or a combination thereof. A burst can be of any appropriate length. In an example embodiment, the data rate is low in order to minimize or reduce the amount of power consumed by the device. In another example embodiment, the heartbeat signal can comprise continuously transmitted RF energy that is monitored periodically or aperiodically at an appropriate data rate. The heartbeat signal can be monitored periodically, aperiodically, or a combination thereof. In various example embodiments, the heartbeat signal can be encrypted or unencrypted. Individual bursts of energy can be shaped to enhance reception and processing of the heartbeat signal. It is to be understood, that although described as an RF signal, the heartbeat signal is not limited thereto. For example, the heartbeat signal can be implemented as any appropriate electromagnetic signal, an optical signal, an acoustic signal, or a combination thereof. The heartbeat signal can be provided wirelessly or via a hard-wired connection.

The device 2 can comprise any appropriate device configured to receive the heartbeat signal. The device 2 can be a stationary device or a mobile device. Referring again to FIG. 1, in an example embodiment, the device 2 is a mobile device in communication with a security policy server 8 via a wireless network 4 and network 6. The security policy server 8 can comprise any appropriate processor (e.g., computer, server, network entity, etc.). The security policy server 9 can be implemented in a single processor or multiple processors. Multiple processors can be distributed or centrally located. Multiple processors can communicate wirelessly, via hard wire, or a combination thereof. The security policy server 8 is indicative of any processor or processors configured to provide a heartbeat signal to the device 2, maintain security policies for the device 2, and respond to the device 2. For example, a security policy server 8 can be implemented as a dedicated processor, or any combination of existing network processors, or a combination thereof. Thus, functionality of the security policy server 8 can be implemented via software, firmware, and/or hardware modifications to appropriate dedicated and/or existing network processors.

As inferred above, there may be circumstances in which the device does not detect the heartbeat signal. This can occur for several reasons. For example, the device 2 may not detect the heartbeat signal because the device 2 has been moved into an area that is not in communication with a network. For example, the device 2 could be in a tunnel, underground, in an airplane, or in a dead zone. In this situation, the user of the device 2 is requested, by the device 2, to provide authorization to use the device. This authorization can comprise any appropriate authorization, such as, for example, a password, a user ID, a designated key word or secret, a cryptographic key, biometric information (e.g., fingerprint, retinal scan, voice recognition, facial recognition, etc.), or any combination thereof. Various types of biometric information can be provided as authorization. For example, the user can place a finger on a fingerprint reader of the device 2. In an example embodiment, a camera on the device can be utilized to capture a visual representation of a fingerprint. Accordingly, the user can place a finger in front of the camera on the device 2. Software, firmware, and/or hardware on the device 2 and/or on the security policy server 8 can analyze the fingerprint information to determine authenticity. Other biometric information can include voice information in the form of a spoken word or phrase. Voice recognition software, firmware, and/or hardware on the device 2 and/or on the security policy server 8 can analyze the word or phrase to determine authenticity. A retina of the user can be used to provide biometric information for authentication. For example, the user can look into a retinal scanner or a camera of the device 2. Software, firmware, and/or hardware on the device 2 and/or on the security policy server 8 can analyze the retinal information to determine authenticity. Facial recognition can be utilized to authenticate the user. The user can look into a camera on the device 2 and software, firmware, and/or hardware on the device 2 and/or on the security policy server 8 can analyze the facial characteristics captured by the camera to determine authenticity. If the authorization provided by the user is determined, by the device 2, to be correct (e.g., the user is authenticated), the user is allowed to perform operations on the device 2.

As another example why the device 2 may not detect the heartbeat signal, the device 2 could have been stolen or misplaced. When the owner of the device discovers that the device 2 is missing, the owner can notify the security policy server 8. In response to the notification, the security policy server 8 can cease transmitting the heartbeat signal to the device 2. In an example embodiment, to mitigate harm due to theft or loss of the device 2, the user of the device 2 could be required to check in (provide authentication) with the security policy server 8 in order for the security policy server 8 to continue providing the heartbeat signal. The user can be provided a reminder to check in with the security policy server 8, either periodically (e.g., once an hour), randomly (e.g., at least once every hour), as selected by the user (e.g., selectable from never to once every 5 minutes), or at any appropriate time (e.g., at the occurrence of designated events such as power up, opening a file, starting an application, etc.). If the user provides authentication within a predetermined amount of time (e.g., 5 minutes), normal operation of the device 2 is allowed. If authentication is not provided within the predetermined amount of time, appropriate action is taken. In an example configuration, the user can check in with the security policy server 8 unsolicited, thus restarting the clock for a previously selected mode (periodic, random, user-defined.). Checking in with the security policy server 8 can include, for example, providing a password, a user ID, a designated key word or secret, a cryptographic key, or any combination thereof. If the user does not check in with the security policy server 8, the security policy server 8 will discontinue providing the heartbeat signal. When the device 2 looks for the heartbeat signal, the heartbeat signal will not be detected, and the device 2 will initiate the appropriate action. In an example embodiment, in an attempt to minimize annoyance of the user, the user can check in with the security policy server utilizing biometrics. For example, the user can receive a prompt, via the device to, to touch a fingerprint reader (or place in front of camera) on the device 2. When the fingerprint reader reads the users registered finger print, the device 2 can send the appropriate information to the security policy server 8. Other types of biometrics are applicable, such as, for example, a retinal scanner/camera, voice recognizer, a facial characteristic recognizer, or a combination thereof. Accordingly, when prompted, or unsolicited, the user can look into a retinal scanner or camera on the device 2, or speak a predetermined word or phrase, to check in with the security policy server 8.

The device 2 may not detect the heartbeat signal because the device 2 was moved out of a designated geographic area (e.g., a high-security area, a designated office, a designated building, a designated laboratory, etc.) in which normal operations or the device 2 is limited or restricted. Restrictions and/or appropriate action can be undertaken depending upon the location of the device 2. For example, the device 2 can be located in a designated area, such a secure area (e.g., designated office or laboratory), in which access to designated files and/or applications is allowed. If the device 2 is moved out of the designated area, access to the designated files and/or applications is denied. Thus, appropriate action is taken when the device is not located in the designated geographic region. As another example, the designated area could be the personnel office of a corporation. Designated files can include files containing Social Security numbers. While the device 2 is located within the personnel office, files containing Social Security numbers are accessible. When the device 2 moves out of the personnel office, access to the files containing Social Security numbers is denied.

When the security policy server 8 determines that the device 2 was moved out of the designated area, the security policy server 8 will cease transmitting the heartbeat signal to the device 2. Accordingly, the device 2 will take appropriate action. The security policy server 8 can be notified that the device 2 has been moved out of the geographic area via any appropriate mechanism, such as, for example, a GPS location capability of the device 2, an A-GPS location capability of the device 2, a location based service (LBS) provided by a network carrier or service provider for the device 2, a time difference of arrival calculation, or a combination thereof. Similarly, the device 2 may not detect the heartbeat signal because the device 2 was moved into a designated geographic area in which the device 2 is not allowed to operate (e.g., shopping mall, lunch room, library, etc.). When the security policy server 8 determines that the device 2 was moved into the designated area, the security policy server 8 will cease transmitting the heartbeat signal to the device 2, and the device 2 will take appropriate action. The security policy server 8 can be notified that the device 2 has been moved into the geographic area via any appropriate mechanism as described above.

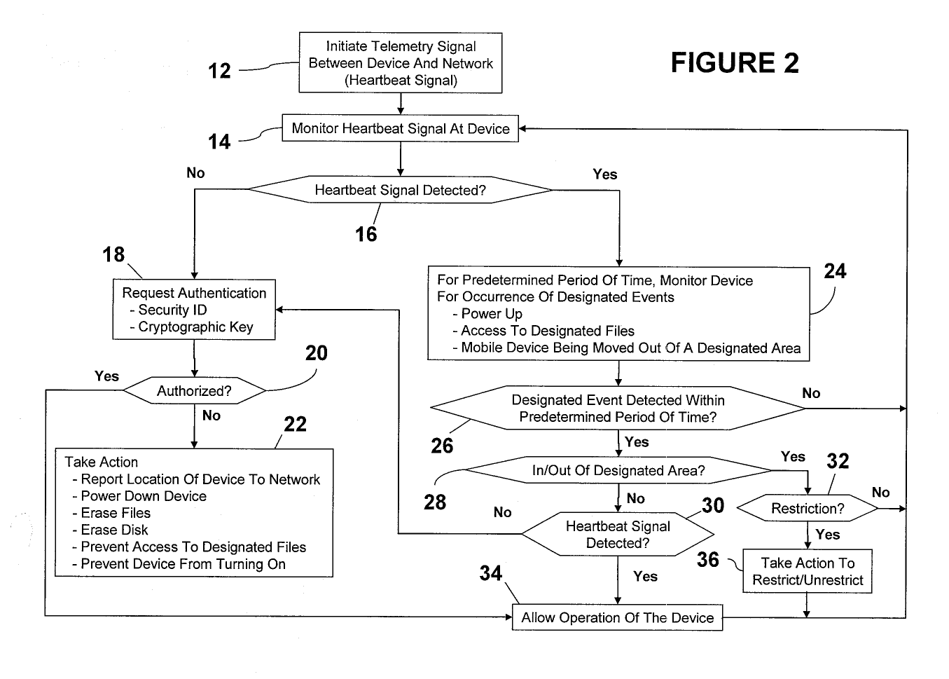

FIG. 2 is a flow diagram of an example process for maintaining security of a device via a heartbeat signal. The heartbeat signal is initiated at step 12. The heartbeat signal can be initiated automatically, manually, or combination thereof. For example, when the device is turned on, the heartbeat signal can automatically be initiated. That is, the device can send a signal to the network indicating that it is being powered up, and the network can initiate transmission of the heartbeat signal. Additionally, the heartbeat signal can be initiated manually. For example, the user can tell the network to initiate or discontinue the heartbeat signal.

The heartbeat signal is monitored (looked for) by the device at step 14. Any appropriate portion, or portions, of the device can receive and process the heartbeat signal. In an example configuration, as the network provides a low data rate, non-continuous, heartbeat signal to the device, the device can responds to each received “of the heartbeat signal. In another example configuration, the network provides the heartbeat signal to the device, wherein the device provides no response. In yet another example configuration, the network can provide the heartbeat signal to the device and the device can respond to the network in accordance with an indication of a request for response embedded in the heartbeat signal. The response can be automatically or manually provided. For example, the network can provide the heartbeat signal to the device at a predetermined date rate (e.g., network sends heartbeat signal to device once every 30 seconds), and once every five minutes embeds an indication of a request in the heartbeat signal for the device to automatically respond to the heartbeat signal. The device, receiving this request, and if able to do so, automatically sends a response signal to the network. Additionally, about every 30 minutes (or as selected by the user), the network can embed an indication of a request in the heartbeat signal for a manual response. When the device receives the request for a manual response, the device, via its user interface (UI), provides an indication to the user to enter a response. The manual response can be in the form of, for example, a password, a secret, or any appropriate indication of a response. The manual response can be response previously determined by the user and established as an authorized response with the network. The manual response can be in any appropriate form, such as, for example, a textual response (e.g., keyboard entered password), an audio response (e.g., voice response), a biometric response (e.g., fingerprint, retina, facial pattern), or the like.

At step 16, as the device is monitoring (looking for) the heartbeat signal (at step 14), it is determined if the heartbeat signal is detected. If the heartbeat signal is detected (at step 16), device operations are allowed to continue. If the heartbeat signal is not detected (at step 16), appropriate action is taken. The heartbeat signal may fail to be detected (at step 16) for any of multiple reasons. For example, the device may have been lost or stolen. When the owner of the device discovers that the device is missing, the owner can notify the network. In response to the notification, the network will cease transmitting the heartbeat signal. As another example, the device may be unable to receive the heartbeat signal because the device is in an in an airplane, a tunnel, underground, a dead zone, or the like. The network, not receiving an automatic response and/or a manual response within a predetermined amount of time, will discontinue sending the heartbeat signal. In this case, as described in more detail below, the user can be given the opportunity to perform operations on the device by providing proper authentication.

If, at step 16, the heartbeat signal is not detected, the user is requested to provide authentication, via the device, at step 18. If authentication is provided to the device, the device is allowed to perform normal operations. Authentication can comprise any appropriate authentication, for example, a secret, a password, to secure identifier (security ID), a cryptographic key, or the like. The authentication can be in any appropriate form, such as, for example, a textual response (e.g., keyboard entered password), an audio response (e.g., voice response), a biometric response (e.g., fingerprint), or the like.

At step 20, it is determined if the authentication provided is proper, and thus, if the user is authorized to operate the device. The user can be determined to be authorized, or not authorized, in any appropriate matter, such as, for example, comparing the provided authentication with an expected, stored, indication of the authentication, using the provided authentication to decrypt an encrypted value indicative of proper authentication, or the like. If it is determined that the user is authorized (at step 20), operation of the device is allowed at step 34. From step 34 the process continues at step 14, wherein the device monitors (looks for) the heartbeat signal.

If, it is determined (at step 20) that the user is not authorized, appropriate action is taken at step 22. Appropriate action can include any type of appropriate action. For example, appropriate action can include any combination of: reporting the location of the device to the network, powering down the device, preventing access to a file or files, erasing a file or files, erasing a desk or desks of the device, preventing the device from turning, or the like. For example, if the device is lost or stolen, and the heartbeat signal is discontinued by the network because the device has not provided a manual and/or automatic response, the device can automatically send an indication of its location to the network. Access to a file or application can be accomplished in any appropriate matter. For example, access can be denied to a file or application unless a user of the device provides the appropriate administrator permissions. As another example, access can be denied to a file or application by encrypting the file or application or portion thereof. In an example embodiment, the decryption of the file or application can be accomplished via a cryptographic key. A cryptographic key, or indication era of, would be maintained and kept secret by the user. A cryptographic key would not be expected to be known by an unauthorized person. The device can determine its location in accordance with any appropriate means. For example, the device can determine its location utilizing the Global Positioning System (GPS), time difference of arrival calculations, assisted GPS (A-GPS), or a combination thereof. If the device is in a location that prevents the device from communicating with the network (e.g., an airplane or the like), the device, upon gaining communication with a network, can send an indication of its location to the network.

In an example configuration, files, applications, peripherals, disks, or a combination thereof can be designated such that appropriate action is taken with respect to the designation. For example, if a file contain sensitive data, such as, for example, Social Security numbers, personal information, classified information, or the like, it can be designated such that went appropriate action is taken the action is taken on that file. In an example scenario, a user may have files containing the user's employees' Social Security numbers stored on the device. The user can designate the files as having sensitive information. If the heartbeat signal is not detected, and the user is not authorized to operate the device, the device can automatically deny access to the files containing the Social Security numbers or the device can automatically erase the files containing Social Security numbers. In another example scenario, access to a peripheral to be denied. For example, if the place comprises a USB port, access to any peripheral connected via the USB port can be denied. Thus, removal of information via the USB port would be prevented.

If, at step 16, the heartbeat signal is detected, the device, at step 24, looks for the occurrence of designated events within a predetermined amount time. The predetermined amount of time can be any appropriate amount of time. In an example embodiment, the predetermined amount of time it the amount of time before the device next checks for the heartbeat signal. A designated event can include any appropriate event such as powering up the device, accessing a designated file, movement of the device into or out of a designated area, or combination thereof. At step 26, it is determined if a designated event has occurred. If a designated event has not occurred (at step 26), the process proceeds to step 14, wherein device monitors the heartbeat signal. If, at step 26, it is determined that a designated event has occurred, the type of designated event that has occurred is determined at step 28. If it is determined, at step 28, that the device was moved into or out of a designated area, it is determined, at step 32, if any restrictions have been placed on any designated files, applications, peripherals, disks, or like. If restrictions have been placed, appropriate action is taken, at step 36, in accordance with the restriction placed on the designated files, applications, peripherals, disk, or the like. In an example scenario, normal use of the device may be in a designated office in which classified information is processed. And, the files containing the classified information can only be processed in the designated office. These designated files can be marked as restricted files, wherein the files are automatically erased if the device is moved out of the designated office. Thus, if it is determined, at step 28, that the device has been moved out of the designated area (the designated office), and it is determined, at step 32, that the restriction placed on the files is to erase the files and move data that has an office, the files are erased at step 36, when the device is moved out of the designated office. The process then proceeds to step 14, wherein device monitors the heartbeat signal.

In another example scenario, similar to the above scenario, the restriction placed on the designated files may be such that access to the designated files is denied while the device is not within the designated area, and access to the designated files is granted when the device is located within the designated area. Thus, if the device is outside of the designated office and it is determined, at step 28, that the device is moved into a designated area (the designated office), and it is determined, at step 34, that the restriction placed on the files is to allow access to the files when the device is moved into the designated office, access to the designated files is granted at step 36. If, at step 32, there are no restrictions placed on any designated files, the process proceeds to step 14, wherein device monitors the heartbeat signal.

If, at step 28, it is not determined that the device has been moved into or out of a designated area, he is determined, at step 30, if the heartbeat signal is being detected. If the heartbeat signal is being detected (at step 30), operation of the devices allow at step 34, and the process proceeds there from to step 14, wherein device monitors the heartbeat signal. If, at step 30, the heartbeat signal is not detected, the process proceeds to step 18, and processing therefrom is as described above.

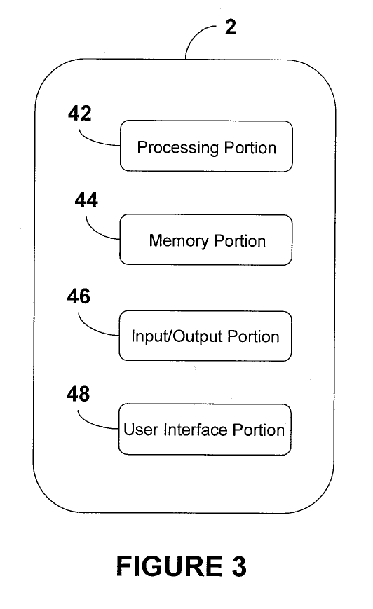

FIG. 3 is a block diagram of an example device 2. The device 2 can include any appropriate device for which security can be maintained via a heartbeat signal as described herein. For example, the device 2 can include a portable device. Examples of which include a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a walkmans, etc.), a portable navigation device (e.g., GPS compatible device, A-GPS compatible device, etc.), or a combination thereof. The device 2 can include devices that are not typically thought of as portable, such as, for example, a public computing device, a navigation device installed in-vehicle, a set top box, or the like. The device 2 can include non-conventional computing devices, such as, for example, a kitchen appliance, a motor vehicle control (e.g., steering wheel), etc., or the like.

In an example configuration, the device 2 comprises a processing portion 42, a memory portion 44, an input/output portion 46, and a user interface (UI) portion 48. It is emphasized that the block diagram depiction of device 2 is exemplary and not intended to imply a specific implementation. For example, in an example configuration, the device 2 comprises a cell phone and the processing portion 42 and/or the memory portion 44 are implemented, in part or in total, on a subscriber identity module (SIM) of the device 2. In another example configuration, the device 2 comprises a laptop computer. The laptop computer can include a SIM, and various portions of the processing portion 42 and/or the memory portion 44 can be implemented on the SIM, on the laptop other than the SIM, or any combination thereof.

The processing portion 42, memory portion 44, and input/output portion 46 are coupled together (coupling not shown in FIG. 3) to allow communications therebetween. In various embodiments, the input/output portion 46 comprises a receiver of the device 2, a transmitter of the device 2, or a combination thereof. The input/output portion 46 is capable of receiving and/or providing information in order to maintain security of the device via a heartbeat signal as described above. For example, the input/output portion 46 is capable of receiving the heartbeat signal, responding to the heartbeat signal, providing information associated with the heartbeat signal, providing an automatic response to the heartbeat signal, providing a manual response to the heartbeat signal, providing and/or receiving an indication of location of the device 2, or any combination thereof. In various configurations, the input/output portion 46 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In various configurations, the input/output portion 46 can receive and/or provide information wirelessly, via a wired connection, or a combination thereof.

The processing portion 42 is capable of performing functions in order to maintain security of the device via a heartbeat signal as described above. For example, the processing portion 42 is capable of processing the heartbeat signal and information associated therewith, such as decoding the heartbeat signal as received from the input/output portion 46, monitoring the heartbeat signal, determining if the heartbeat signal is detected, determining if the heartbeat signal is not detected, processing the heartbeat signal to determine if a request for response is indicated therein, determining the occurrence of designated event, determining the location of the device 2, determining if the device 2 has moved into or out of a designated area, requesting authorization via the user interface (UI) portion 48 of the device 2, determining if provided authorization is proper (e.g., user is authorized), taking any appropriate action, reporting a location of the device, powering down the device, erasing a file, erasing a disk, preventing access to a file, allowing access to a file, preventing the device from being turned on, allowing operation of the device, determining if a file or application, is designated or restricted, preventing access to a peripheral, allowing access to a peripheral, or any combination thereof.

In a basic configuration, the device 2 can include at least one processing portion 42 and memory portion 44. The memory portion 44 can store any information utilized in conjunction with maintaining security of the device 2 via the heartbeat signal. For example, the memory portion 44 is capable of storing authentication information, a security identifier, a cryptographic key, a password, a secret, a user ID, an indication as to whether a file is restricted or not, an indication as to whether a file is a designated file or not, an indication of a designated area, or a combination thereof. Depending upon the exact configuration and type of processor, the memory portion 44 can be volatile (such as RAM), non-volatile (such as ROM, flash memory, etc.), or a combination thereof. The device 2 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the device 2.

The device 2 also can contain a UI portion 48 allowing a user to communicate with the device 2. The UI portion 48 can provide the ability to control the device 2, via, for example, buttons, soft keys, voice actuated controls, a touch screen, movement of the device 2, visual cues (e.g., moving a hand in front of a camera on the device 2), or the like. The UI portion 48 can provide visual information (e.g., via a display), audio information (e.g., via speaker), mechanically (e.g., via a vibrating mechanism), or a combination thereof. In various configurations, the UI portion 48 can comprise a display, a touch screen, a keyboard, an accelerometer, a motion detector, a speaker, a microphone, a camera, a tilt sensor, or any combination thereof. The UI portion 48 can comprise means for inputting biometric information, such as, for example, fingerprint information, retinal information, voice information, and/or facial characteristic information.

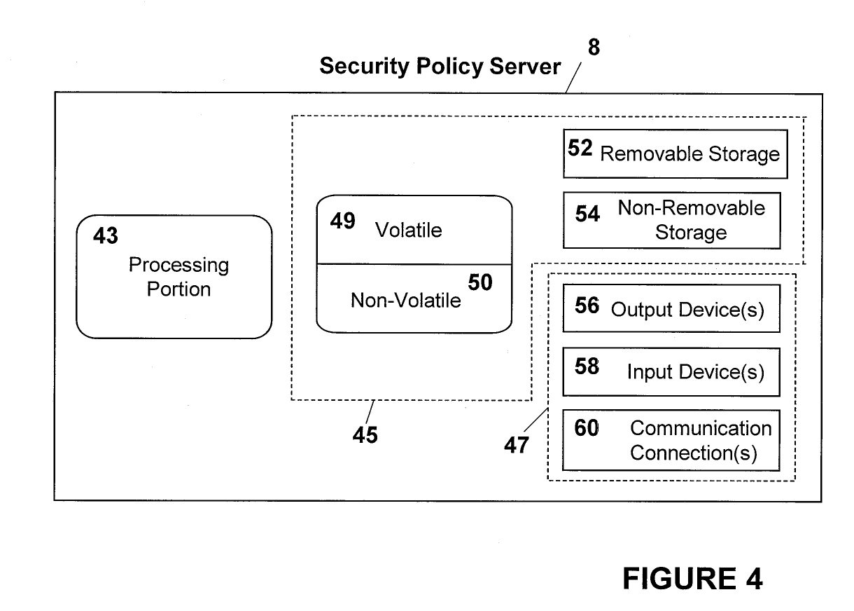

FIG. 4 is a block diagram of an example security policy server 8 for maintaining device security via a heartbeat signal. The security policy server 8 depicted in FIG. 4 represents any appropriate network entity, such as a processor, a server, a gateway, or the like. In an example configuration, the security policy server 8 comprises a component or various components of a cellular broadcast system wireless network. It is emphasized that the block diagram depicted in FIG. 4 is exemplary and not intended to imply a specific implementation or configuration. Thus, the security policy server 8 can be implemented in a single processor or multiple processors (e.g., single server or multiple servers, single gateway or multiple gateways). Multiple security policy servers can be distributed or centrally located. Multiple security policy servers can communicate wirelessly, via hard wire, or a combination thereof.

In an example configuration, the security policy server 8 comprises a processing portion 43, a memory portion 45, and an input/output portion 47. The processing portion 43, memory portion 45, and input/output portion 47 are coupled together (coupling not shown in FIG. 4) to allow communications therebetween. The input/output portion 47 is capable of receiving and/or providing information in order to maintain security of the device (e.g., device 2) via a heartbeat signal as described above. For example, the input/output portion 47 is capable of receiving and/or providing the heartbeat signal and information associated with the heartbeat signal, an automatic response to the heartbeat signal, a manual response to the heartbeat signal, an indication of location of the device, or any commendation thereof. The input/output portion 47 is capable of providing an indication to the device to power down the device, providing an indication to the device to erase a file, providing an indication to the device to erase a disk, providing an indication to the device to prevent access to a file, providing an indication to the device to allow access to a file on the device, providing an indication to the device to prevent the device from being turned on, providing an indication to the device to allow operation of the device, providing an indication to the device to prevent access to a peripheral of the device, providing an indication to the device to allow access to a peripheral of the device, or any combination thereof.

The processing portion 43 is capable of performing functions in order to maintain security of the device via a heartbeat signal as described above. For example, the processing portion 43 is capable of processing the heartbeat signal and information associated therewith, monitoring the heartbeat signal, determining the location of the device, determining if the device has moved into or out of a designated area, determining if provided authorization is proper (e.g., user is authorized), reporting a location of the device, of a combination thereof.

In a basic configuration, the security policy server 8 can include at least one processing portion 43 and memory portion 45. The memory portion 45 can store any information utilized in conjunction with maintaining security of a device via a heartbeat signal. For example, the memory portion 45 is capable of storing authentication information, a security identifier, a cryptographic key, a password, a secret, a user ID, an indication as to whether a file on the device is restricted or not, an indication as to whether a file on the device is a designated file or not, an indication of a designated geographic area, or a combination thereof. Depending upon the exact configuration and type of security policy server, the memory portion 45 computer readable storage media that is volatile 49 (such as RAM), non-volatile 50 (such as ROM, flash memory, etc.), or a combination thereof. The security policy server 8 can include additional storage, in the form of computer readable storage media (e.g., removable storage 52 and/or non-removable storage 54) including, but not limited to, RAM, ROM, EEPROM, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the security policy server 8.

The security policy server 8 also can contain communications connection(s) 60 that allow the security policy server 8 to communicate with other devices, network entities, or the like. A communications connection(s) can comprise communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. The term computer readable media as used herein includes both storage media and communication media. The processor also can have input device(s) 58 such as keyboard, mouse, pen, voice input device, touch input device, etc. Output device(s) 56 such as a display, speakers, printer, etc. also can be included.

The following description sets forth some exemplary telephony radio networks and non-limiting operating environments in which device security can be maintained via a heartbeat signal. The below-described operating environments should be considered non-exhaustive, however, and thus the below-described network architectures merely show how a maintaining device security via a heartbeat signal can be incorporated into existing network structures and architectures. It can be appreciated, however, that maintaining device security via a heartbeat signal can be incorporated into existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (“GPRS”), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), 4G Services such as Long Term Evolution (LTE), etc., as well as to other network services that become available in time. In this regard, the techniques of the utilization of SMS and/or cellular broadcast to receive multimedia alerts can be applied independently of the method of data transport, and do not depend on any particular network architecture, or underlying protocols.

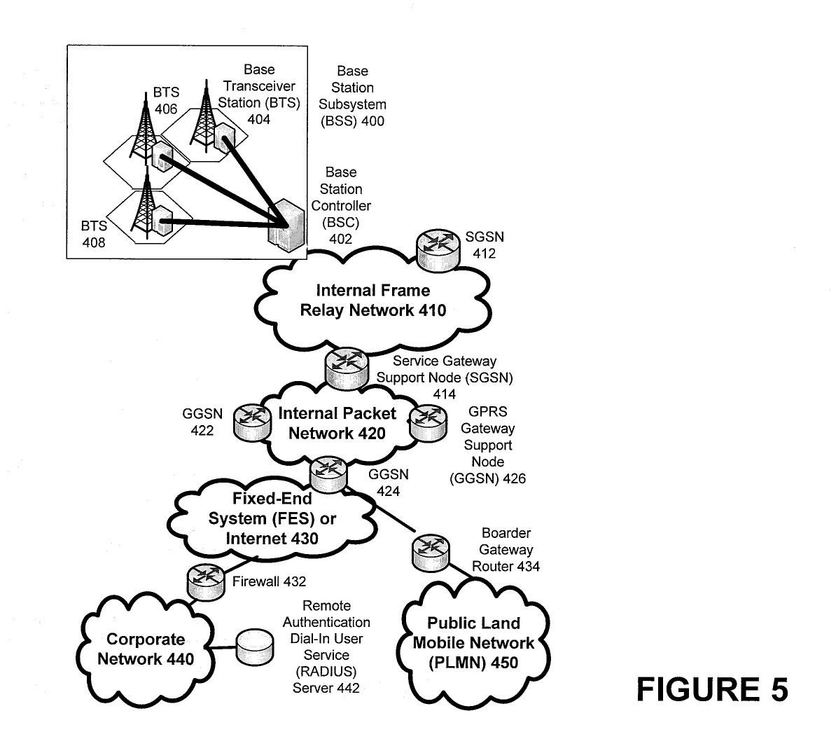

FIG. 5 depicts an overall block diagram of an exemplary packet-based mobile cellular network environment, such as a GPRS network, in which device security can be maintained via a heartbeat signal. In an example configuration, the wireless network 4, the communications network 6, the security policy server 8, or a combination thereof, is encompassed by the network environment depicted in FIG. 5. In such an environment, there are a plurality of Base Station Subsystems (“BSS”) 400 (only one is shown), each of which comprises a Base Station Controller (“BSC”) 402 serving a plurality of Base Transceiver Stations (“BTS”) such as BTSs 404, 406, and 408. BTSs 404, 406, 408, etc. are the access points where users of packet-based mobile devices become connected to the wireless network. In exemplary fashion, the packet traffic originating from user devices (e.g., mobile devices) is transported via an over-the-air interface to a BTS 408, and from the BTS 408 to the BSC 402. Base station subsystems, such as BSS 400, are a part of internal frame relay network 410 that can include Service GPRS Support Nodes (“SGSN”) such as SGSN 412 and 414. Each SGSN is connected to an internal packet network 420 through which a SGSN 412, 414, etc. can route data packets to and from a plurality of gateway GPRS support nodes (GGSN) 422, 424, 426, etc. As illustrated, SGSN 414 and GGSNs 422, 424, and 426 are part of internal packet network 420. Gateway GPRS serving nodes 422, 424 and 426 mainly provide an interface to external Internet Protocol (“IP”) networks such as Public Land Mobile Network (“PLMN”) 450, corporate intranets 440, or Fixed-End System (“FES”) or the public Internet 430. As illustrated, subscriber corporate network 440 may be connected to GGSN 424 via firewall 432; and PLMN 450 is connected to GGSN 424 via boarder gateway router 434. The Remote Authentication Dial-In User Service (“RADIUS”) server 442 may be used for caller authentication when a user of a mobile cellular device calls corporate network 440.

Generally, there can be four different cell sizes in a GSM network, referred to as macro, micro, pico, and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. On the other hand, umbrella cells are used to cover shadowed regions of smaller cells and fill in gaps in coverage between those cells.

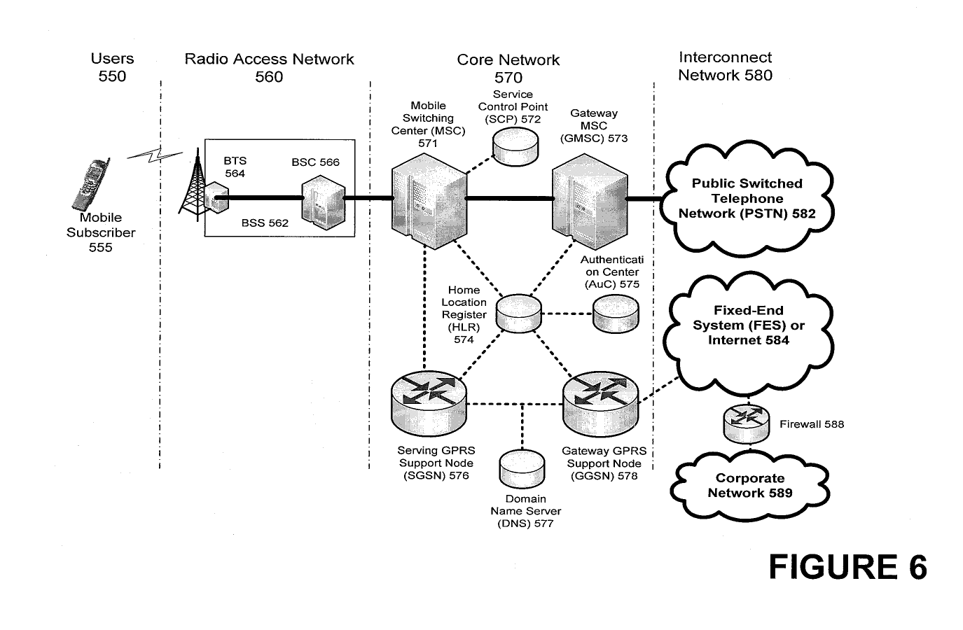

FIG. 6 illustrates an architecture of a typical GPRS network in which device security can be maintained via a heartbeat signal. The architecture depicted in FIG. 6 is segmented into four groups: users 550, radio access network 560, core network 570, and interconnect network 580. Users 550 comprise a plurality of end users (though only mobile subscriber 555 is shown in FIG. 6). In an example embodiment, the device depicted as mobile subscriber 555 comprises a mobile device. Radio access network 560 comprises a plurality of base station subsystems such as BSSs 562, which include BTSs 564 and BSCs 566. Core network 570 comprises a host of various network elements. As illustrated here, core network 570 may comprise Mobile Switching Center (“MSC”) 571, Service Control Point (“SCP”) 572, gateway MSC 573, SGSN 576, Home Location Register (“HLR”) 574, Authentication Center (“AuC”) 575, Domain Name Server (“DNS”) 577, and GGSN 578. Interconnect network 580 also comprises a host of various networks and other network elements. As illustrated in FIG. 6, interconnect network 580 comprises Public Switched Telephone Network (“PSTN”) 582, Fixed-End System (“FES”) or Internet 584, firewall 588, and Corporate Network 589.

A mobile switching center can be connected to a large number of base station controllers. At MSC 571, for instance, depending on the type of traffic, the traffic may be separated in that voice may be sent to Public Switched Telephone Network (“PSTN”) 582 through Gateway MSC (“GMSC”) 573, and/or data may be sent to SGSN 576, which then sends the data traffic to GGSN 578 for further forwarding.

When MSC 571 receives call traffic, for example, from BSC 566, it sends a query to a database hosted by SCP 572. The SCP 572 processes the request and issues a response to MSC 571 so that it may continue call processing as appropriate.

The HLR 574 is a centralized database for users to register to the GPRS network. HLR 574 stores static information about the subscribers such as the International Mobile Subscriber Identity (“IMSI”), subscribed services, and a key for authenticating the subscriber. HLR 574 also stores dynamic subscriber information such as the current location of the mobile subscriber. Associated with HLR 574 is AuC 575. AuC 575 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 6, when mobile subscriber 555 initiates the attach process by turning on the network capabilities of the mobile device, an attach request is sent by mobile subscriber 555 to SGSN 576. The SGSN 576 queries another SGSN, to which mobile subscriber 555 was attached before, for the identity of mobile subscriber 555. Upon receiving the identity of mobile subscriber 555 from the other SGSN, SGSN 576 requests more information from mobile subscriber 555. This information is used to authenticate mobile subscriber 555 to SGSN 576 by HLR 574. Once verified, SGSN 576 sends a location update to HLR 574 indicating the change of location to a new SGSN, in this case SGSN 576. HLR 574 notifies the old SGSN, to which mobile subscriber 555 was attached before, to cancel the location process for mobile subscriber 555. HLR 574 then notifies SGSN 576 that the location update has been performed. At this time, SGSN 576 sends an Attach Accept message to mobile subscriber 555, which in turn sends an Attach Complete message to SGSN 576.

After attaching itself with the network, mobile subscriber 555 then goes through the authentication process. In the authentication process, SGSN 576 sends the authentication information to HLR 574, which sends information back to SGSN 576 based on the user profile that was part of the user's initial setup. The SGSN 576 then sends a request for authentication and ciphering to mobile subscriber 555. The mobile subscriber 555 uses an algorithm to send the user identification (ID) and password to SGSN 576. The SGSN 576 uses the same algorithm and compares the result. If a match occurs, SGSN 576 authenticates mobile subscriber 555.

Next, the mobile subscriber 555 establishes a user session with the destination network, corporate network 589, by going through a Packet Data Protocol (“PDP”) activation process. Briefly, in the process, mobile subscriber 555 requests access to the Access Point Name (“APN”), for example, UPS.com, and SGSN 576 receives the activation request from mobile subscriber 555. SGSN 576 then initiates a Domain Name Service (“DNS”) query to learn which GGSN node has access to the UPS.com APN. The DNS query is sent to the DNS server within the core network 570, such as DNS 577, which is provisioned to map to one or more GGSN nodes in the core network 570. Based on the APN, the mapped GGSN 578 can access the requested corporate network 589. The SGSN 576 then sends to GGSN 578 a Create Packet Data Protocol (“PDP”) Context Request message that contains necessary information. The GGSN 578 sends a Create PDP Context Response message to SGSN 576, which then sends an Activate PDP Context Accept message to mobile subscriber 555.

Once activated, data packets of the call made by mobile subscriber 555 can then go through radio access network 560, core network 570, and interconnect network 580, in a particular fixed-end system or Internet 584 and firewall 588, to reach corporate network 589.

Thus, network elements that can invoke the functionality of maintaining device security via a heartbeat signal can include but are not limited to Gateway GPRS Support Node tables, Fixed End System router tables, firewall systems, VPN tunnels, and any number of other network elements as required by the particular digital network.

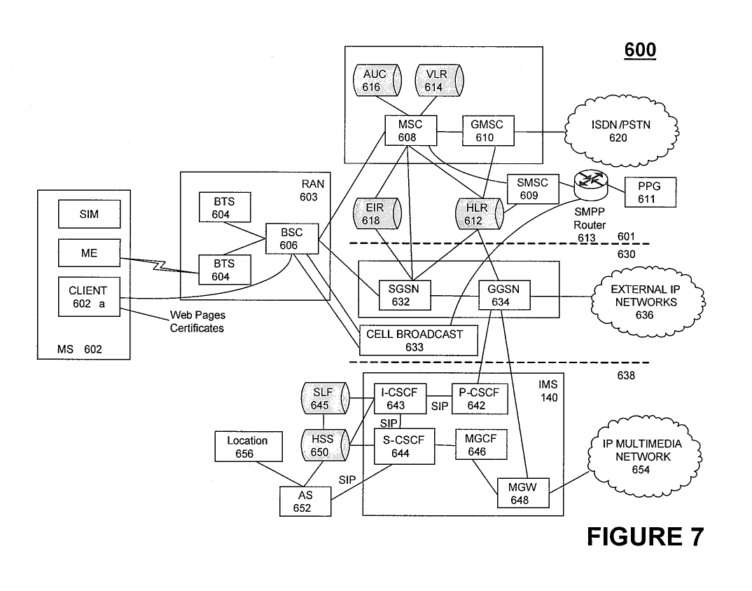

FIG. 7 illustrates an exemplary block diagram view of a GSM/GPRS/IP multimedia network architecture 600 within which device security can be maintained via a heartbeat signal. As illustrated, architecture 600 of FIG. 7 includes a GSM core network 601, a GPRS network 630 and an IP multimedia network 638. The GSM core network 601 includes a Mobile Station (MS) 602, at least one Base Transceiver Station (BTS) 604 and a Base Station Controller (BSC) 606. The MS 602 is physical equipment or Mobile Equipment (ME), such as a mobile phone or a laptop computer (e.g., user device 22) that is used by mobile subscribers, with a Subscriber identity Module (SIM). The SIM includes an International Mobile Subscriber Identity (IMSI), which is a unique identifier of a subscriber. The BTS 604 is physical equipment, such as a radio tower, that enables a radio interface to communicate with the MS. Each BTS may serve more than one MS. The BSC 606 manages radio resources, including the BTS. The BSC may be connected to several BTSs. The BSC and BTS components, in combination, are generally referred to as a base station (BSS) or radio access network (RAN) 603.

The GSM core network 601 also includes a Mobile Switching Center (MSC) 608, a Gateway Mobile Switching Center (GMSC) 610, a Home Location Register (HLR) 612, Visitor Location Register (VLR) 614, an Authentication Center (AuC) 618, and an Equipment Identity Register (EIR) 616. The MSC 608 performs a switching function for the network. The MSC also performs other functions, such as registration, authentication, location updating, handovers, and call routing. The GMSC 610 provides a gateway between the GSM network and other networks, such as an Integrated Services Digital Network (ISDN) or Public Switched Telephone Networks (PSTNs) 620. Thus, the GMSC 610 provides interworking functionality with external networks.

The HLR 612 is a database that contains administrative information regarding each subscriber registered in a corresponding GSM network. The HLR 612 also contains the current location of each MS. The VLR 614 is a database that contains selected administrative information from the HLR 612. The VLR contains information necessary for call control and provision of subscribed services for each MS currently located in a geographical area controlled by the VLR. The HLR 612 and the VLR 614, together with the MSC 608, provide the call routing and roaming capabilities of GSM. The AuC 616 provides the parameters needed for authentication and encryption functions. Such parameters allow verification of a subscriber's identity. The EIR 618 stores security-sensitive information about the mobile equipment.

A Short Message Service Center (SMSC) 609 allows one-to-one Short Message Service (SMS) messages to be sent to/from the MS 602. A Push Proxy Gateway (PPG) 611 is used to “push” (i. e., send without a synchronous request) content to the MS 602. The PPG 611 acts as a proxy between wired and wireless networks to facilitate pushing of data to the MS 602. A Short Message Peer to Peer (SMPP) protocol router 613 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 602 sends a location update including its current location information to the MSC/VLR, via the BTS 604 and the BSC 606. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 630 is logically implemented on the GSM core network architecture by introducing two packet-switching network nodes, a serving GPRS support node (SGSN) 632, a cell broadcast and a Gateway GPRS support node (GGSN) 634. The SGSN 632 is at the same hierarchical level as the MSC 608 in the GSM network. The SGSN controls the connection between the GPRS network and the MS 602. The SGSN also keeps track of individual MS's locations and security functions and access controls.

A Cell Broadcast Center (CBC) 633 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 634 provides a gateway between the GPRS network and a public packet network (PDN) or other IP networks 636. That is, the GGSN provides interworking functionality with external networks, and sets up a logical link to the MS through the SGSN. When packet-switched data leaves the GPRS network, it is transferred to an external TCP-IP network 636, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 630 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

The IP multimedia network 638 was introduced with 3GPP Release 5, and includes an IP multimedia subsystem (IMS) 640 to provide rich multimedia services to end users. A representative set of the network entities within the IMS 640 are a call/session control function (CSCF), a media gateway control function (MGCF) 646, a media gateway (MGW) 648, and a master subscriber database, called a home subscriber server (HSS) 650. The HSS 650 may be common to the GSM network 601, the GPRS network 630 as well as the IP multimedia network 638.

The IP multimedia system 640 is built around the call/session control function, of which there are three types: an interrogating CSCF (I-CSCF) 643, a proxy CSCF (P-CSCF) 642, and a serving CSCF (S-CSCF) 644. The P-CSCF 642 is the MS's first point of contact with the IMS 640. The P-CSCF 642 forwards session initiation protocol (SIP) messages received from the MS to an SIP server in a home network (and vice versa) of the MS. The P-CSCF 642 may also modify an outgoing request according to a set of rules defined by the network operator (for example, address analysis and potential modification).

The I-CSCF 643, forms an entrance to a home network and hides the inner topology of the home network from other networks and provides flexibility for selecting an S-CSCF. The I-CSCF 643 may contact a subscriber location function (SLF) 645 to determine which HSS 650 to use for the particular subscriber, if multiple HSS's 650 are present. The S-CSCF 644 performs the session control services for the MS 602. This includes routing originating sessions to external networks and routing terminating sessions to visited networks. The S-CSCF 644 also decides whether an application server (AS) 652 is required to receive information on an incoming SIP session request to ensure appropriate service handling. This decision is based on information received from the HSS 650 (or other sources, such as an application server 652). The AS 652 also communicates to a location server 656 (e.g., a Gateway Mobile Location Center (GMLC)) that provides a position (e.g., latitude/longitude coordinates) of the MS 602.

The HSS 650 contains a subscriber profile and keeps track of which core network node is currently handling the subscriber. It also supports subscriber authentication and authorization functions (AAA). In networks with more than one HSS 650, a subscriber location function provides information on the HSS 650 that contains the profile of a given subscriber.

The MGCF 646 provides interworking functionality between SIP session control signaling from the IMS 640 and ISUP/BICC call control signaling from the external GSTN networks (not shown). It also controls the media gateway (MGW) 648 that provides user-plane interworking functionality (e.g., converting between AMR- and PCM-coded voice). The MGW 648 also communicates with other IP multimedia networks 654.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of maintaining device security via a heartbeat signal have been described in connection with various computing devices/processor, the underlying concepts can be applied to any computing device, processor, or system capable of maintaining device security via a heartbeat signal. The various techniques described herein can be implemented in connection with hardware or software or, where appropriate, with a combination of both. Thus, the methods and apparatuses for maintaining device security via a heartbeat signal, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for maintaining device security via a heartbeat signal. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for maintaining device security via a heartbeat signal also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for maintaining device security via a heartbeat signal. When implemented on a general-purpose processor, the program code combines with the processor to provide a unique apparatus that operates to invoke the functionality of maintaining device security via a heartbeat signal. Additionally, any storage techniques used in connection with maintaining device security via a heartbeat signal can invariably be a combination of hardware and software.

While maintaining device security via a heartbeat signal has been described in connection with the various embodiments of the various figures, it is to be understood that other similar embodiments can be used or modifications and additions can be made to the described embodiment for performing the same function of maintaining device security via a heartbeat signal without deviating therefrom. For example, one skilled in the art will recognize that maintaining device security via a heartbeat signal as described herein may apply to any environment, whether wired or wireless, and may be applied to any number of such devices connected via a communications network and interacting across the network. Therefore, maintaining device security via a heartbeat signal should not be limited to any single embodiment, but rather should be construed in breadth and scope in accordance with the appended claims.

What is claimed:

1. A method for maintaining security of a device, the method comprising:
monitoring for a heartbeat signal via the device;
if the heartbeat signal is detected, allowing operation of the device; and
if the heartbeat signal is not detected within a predetermined amount of time, determining an appropriate action to take, taking an appropriate action comprising at least one of:
requesting authorization to allow operation of the device; or
disabling at least one function of the device; and
if the appropriate action comprises requesting authorization to allow operation of the device:
allowing operation of the device upon, if authorization is received responsive to the request; or
disabling the at least one function of the device, if authorization is not received responsive to the request.

2. The method in accordance with claim 1, wherein the authorization comprises biometric information.

3. The method in accordance with claim 1, wherein the device is a mobile device.

4. The method in accordance with claim 1, wherein the heartbeat signal is a telemetry signal between the device and a network.

5. The method in accordance with claim 1, wherein disabling at least one function comprises instructing the device to disallow restart after the device is turned off.

6. The method in accordance with claim 1, wherein disabling the at least one function comprises preventing access to at least one of:
a designated file of the device;
a designated application of the device;
a designated portion of the device; or
a designated peripheral of the device.

7. The method in accordance with claim 1, wherein disabling the at least one function comprises turning the device off.

8. The method in accordance with claim 1, wherein disabling the at least one function comprises erasing at least one of:
a designated file of the device;
designated memory of the device; or
designated memory of a designated peripheral of the device.

9. The method in accordance with claim 1, wherein disabling at least one function comprises encrypting at least one of a file, a document, or an application.

10. The method in accordance with claim 1, wherein appropriate action is taken when the device is not located in a designated geographic region.

11. A device comprising:
a processing portion configured to:
detect a heartbeat signal;
if the heartbeat signal is detected, allow operation of the device; and
if the heartbeat signal is not detected within a predetermined amount of time, determine an appropriate action to take, taking an appropriate action comprising at least one of:
requesting authorization to allow operation of the device; or
disabling at least one function of the device.

12. The device in accordance with claim 11, wherein the processor portion request authorization to allow operation of the device, the processor portion further configured to:
if authorization is received responsive to the request, allow operation of the device upon; and
if authorization is not received responsive to the request, disable at least one function of the device.

13. The device in accordance with claim 12, wherein the authorization comprises biometric information.

14. The device in accordance with claim 11, wherein the device is a mobile device.

15. The device in accordance with claim 11, wherein the heartbeat signal is a telemetry signal between the device and a network.

16. The device in accordance with claim 11, wherein disabling at least one function comprises instructing the device to disallow restart after the device is turned off.

17. The device in accordance with claim 11, wherein disabling the at least one function comprises preventing access to at least one of:
a designated file of the device;
a designated application of the device;
a designated portion of the device; or
a designated peripheral of the device.

18. The device in accordance with claim 11, wherein disabling the at least one function comprises turning the device off.

19. The device in accordance with claim 11, wherein disabling the at least one function comprises erasing at least one of:
a designated file of the device;
designated memory of the device; or
designated memory of a designated peripheral of the device.

20. The device in accordance with claim 11, wherein disabling at least one function comprises encrypting at least one of a file, a document, or an application.

21. The device in accordance with claim 11, wherein appropriate action is taken when the device is not located in a designated geographic region.
